(19) United States
(12) Patent Application Publication
(10) Pub. No.: US 2013/0175746 A1
(43) Pub. Date: Jul. 11, 2013

(54) Energy Absorbing Structure

(71) Applicant: Bijan Khatib-Shahidi, Novi, MI (US)

(72) Inventor: Bijan Khatib-Shahidi, Novi, MI (US)

(21) Appl. No.: 13/346,964

(22) Filed: Jan. 10, 2012

(51) Int. Cl. F16F 1/20; B23P 11/00

(52) U.S. Cl. 267/164; 29/896.9

(57) ABSTRACT

An energy absorbing structure including an ovoid having a first end and a second end, wherein the first end and the second end are opposed; a first arch; and a second arch. The arches are inverted with respect to one another such that first arch legs are opposed to second arch legs. The arches are nested into the ovoid such that apexes of the arches intersect, and the first arch legs intersect a first surface and the second arch legs intersect a second surface. The first end of the ovoid is directed towards the first surface and the second end of the ovoid is directed towards the second surface. When a threat encounters either or both of the first and second surfaces, the structure collapses to absorb energy originated from the threat.

### GOVERNMENT INTEREST

The invention described here may be made, used and licensed by and for the U.S. Government for governmental purposes without paying royalty to me.

### BACKGROUND OF THE INVENTION

1. Field of the Invention The present invention generally relates to an energy absorbing structure.

2. Background Art

A number of conventional approaches for energy absorbing structures have been implemented. Conventional energy absorbing structures that are configured to defeat threats such as impacts, blasts, projectiles, and/or other like articles and events can be heavy, costly, less effective than desired, difficult to manufacture, and the like.

Thus, there exists a need and an opportunity for an improved energy absorbing structure. Such an improved system and method may overcome one or more of the deficiencies of the conventional approaches.

### SUMMARY OF THE INVENTION

Accordingly, the present invention may provide an energy absorbing structure that includes: an ovoid having a first end and a second end, wherein the first end and the second end are opposed; a first arch; and a second arch. The arches are inverted with respect to one another such that first arch legs are opposed to second arch legs, and the arches are nested into the ovoid such that apexes of the arches intersect, and the first arch legs intersect a first surface and the second arch legs intersect a second surface, and the first end of the ovoid is directed towards the first surface and the second end of the ovoid is directed towards the second surface. When a threat encounters either or both of the first and second surfaces, the structure collapses to absorb energy originated from the threat.

The first end of the ovoid is separated from the first surface by a first distance, and the second end of the ovoid is separated from the second surface by a second distance, and the first distance and the second distance are not equal.

The first end of the ovoid is separated from the first surface by a first distance, and the second end of the ovoid is separated from the second surface by a second distance, and the first distance and the second distance are substantially equal.

The first end has a first curvature having a first radius and the second end has a second curvature having a second radius, and the first radius and the second radius are not equal.

The first end has a first curvature having a first radius and the second end has a second curvature having a second radius, and the first radius and the second radius are substantially equal.

The structure is made from at least one of aluminum, steel, titanium, composites, and plastics.

Further provided according to the present invention, an energy absorbing system that includes a plurality of subassemblies positioned between a first surface and a second surface. Each of the subassemblies includes: an ovoid having a first end and a second end, wherein the first end and the second end are opposed; a first arch; and a second arch. The arches are inverted with respect to one another such that first arch legs are opposed to second arch legs, and the arches are nested into the ovoid such that apexes of the arches intersect, and the first arch legs intersect the first surface and the second arch legs intersect the second surface, and the first end of the ovoid is directed towards the first surface and the second end of the ovoid is directed towards the second surface. When a threat encounters either or both of the first and second surfaces, at least one of the subassemblies collapses to absorb energy originated from the threat.

The first end of the ovoid is separated from the first surface by a first distance, and the second end of the ovoid is separated the second surface by a second distance, and the first distance and the second distance are not equal.

The first end of the ovoid is separated from the first surface by a first distance, and the second end of the ovoid is separated from the second surface by a second distance, and the first distance and the second distance are substantially equal.

The first end has a first curvature having a first radius and the second end has a second curvature having a second radius, and the first radius and the second radius are not equal.

The first end has a first curvature having a first radius and the second end has a second curvature having a second radius, and the first radius and the second radius are substantially equal.

The subassemblies are made from at least one of aluminum, steel, titanium, composites, and plastics.

The subassemblies are substantially adjacent.

Also provided according to the present invention, a method for absorbing energy that includes: (i) positioning a plurality of subassemblies between a first surface and a second surface, wherein each of the subassemblies includes: an ovoid having a first end and a second end, wherein the first end and the second end are opposed; a first arch; and a second arch, wherein the arches are inverted with respect to one another such that first arch legs are opposed to second arch legs, and the arches are nested into the ovoid such that apexes of the arches intersect, and the first arch legs intersect the first surface and the second arch legs intersect the second surface, and the first end of the ovoid is directed towards the first surface and the second end of the ovoid is directed towards the second surface; and (ii) positioning at least one of the surfaces between a body to be protected and an anticipated threat. When the threat encounters either or both of the first and second surfaces, at least one of the subassemblies collapses to absorb energy originated from the threat.

The first end of the ovoid is separated from the first surface by a first distance, and the second end of the ovoid is separated from the second surface by a second distance, and the first distance and the second distance are not equal.

The first end of the ovoid is separated from the first surface by a first distance, and the second end of the ovoid is separated from the second surface by a second distance, and the first distance and the second distance are substantially equal.

The first end has a first curvature having a first radius and the second end has a second curvature having a second radius, and the first radius and the second radius are not equal.

The first end has a first curvature having a first radius and the second end has a second curvature having a second radius, and the first radius and the second radius are substantially equal.

The subassemblies are made from at least one of aluminum, steel, titanium, composites, and plastics.

The subassemblies are substantially adjacent.

The above features, and other features and advantages of the present invention are readily apparent from the following detailed descriptions thereof when taken in connection with the accompanying drawings.

### BRIEF DESCRIPTION OF THE DRAWINGS

FIG. 1 is a diagram of an isometric view of an energy absorbing structure of the present invention;

FIG. 2 is an end view of the energy absorbing structure of FIG. 1; and

FIG. 3 is an end view of an embodiment of an implementation of a plurality of the energy absorbing structure of FIG. 1.

### DETAILED DESCRIPTION OF THE PREFERRED EMBODIMENT(S)

Definitions and Terminology:

The following definitions and terminology are applied as understood by one skilled in the appropriate art.

The singular forms such as “a,” “an,” and “the” include plural references unless the context clearly indicates otherwise. For example, reference to “a material” includes reference to one or more of such materials, and “an element” includes reference to one or more of such elements.

As used herein, “substantial” and “about”, when used in reference to a quantity or amount of a material, characteristic, parameter, and the like, refer to an amount that is sufficient to provide an effect that the material or characteristic was intended to provide as understood by one skilled in the art. The amount of variation generally depends on the specific implementation. Similarly, “substantially free of” or the like refers to the lack of an identified composition, characteristic, or property. Particularly, assemblies that are identified as being “substantially free of” are either completely absent of the characteristic, or the characteristic is present only in values which are small enough that no meaningful effect on the desired results is generated.

A plurality of items, structural elements, compositional elements, materials, subassemblies, and the like may be presented in a common list or table for convenience. However, these lists or tables should be construed as though each member of the list is individually identified as a separate and unique member. As such, no individual member of such list should be considered a de facto equivalent of any other member of the same list solely based on the presentation in a common group so specifically described.

Concentrations, values, dimensions, amounts, and other quantitative data may be presented herein in a range format. One skilled in the art will understand that such range format is used for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 dimensional unit to about 100 dimensional units should be interpreted to include not only the explicitly recited limits, but also to include individual sizes such as 2 dimensional units, 3 dimensional units, 10 dimensional units, and the like; and sub-ranges such as 10 dimensional units to 50 dimensional units, 20 dimensional units to 100 dimensional units, and the like.

With reference to the Figures, the preferred embodiments of the present invention will now be described in detail. Generally, the present invention provides an improved system and an improved method for an energy absorbing structure. As well as energy absorbing, the present invention may be implemented to provide strengthening, cushioning, impact absorbing, protection, shock absorbing, and the like. As well as a structure, the present invention may be characterized as an apparatus, assembly, subassembly, component, system, element, cell, device, armor, member, damper, barrier, guard, and the like. Similarly, a method implementing the present invention may also be characterized as a process, blocks, steps, procedure, and the like.

As described in more detail below, certain elements may be synonymously described as egg shaped, oval, ovoid, ovate, ellipsoidal, oblong, elliptical, and the like. Certain elements may be synonymously described as curved, arcuate, arch(ed), wavy, “U” shaped, “C” shaped, and the like. Certain elements may be synonymously described as straight, linear, and the like. Orientation of elements may be synonymously described as parallel, longitudinally aligned, and the like. Elements of the present invention may be intermeshed, interdigitated, nested, combined, overlapped, included, integrated, linked, entwined, joined, fastened, secured, cellular, adhered, coupled, and the like.

The energy absorbing structure of the present invention may be implemented (e.g., configured, adapted, used, positioned, placed, installed, etc.) to defeat threats such as impacts, blasts, projectiles, fragments, energetically propelled debris, and/or other like articles and events. The energy absorbing structure of the present invention is generally implemented between a body to be protected and the anticipated threat. In response to such threats, one or more elements of the present invention generally crush, crumple, collapse, fold, bend, deform, break, delaminate, distort, and the like.

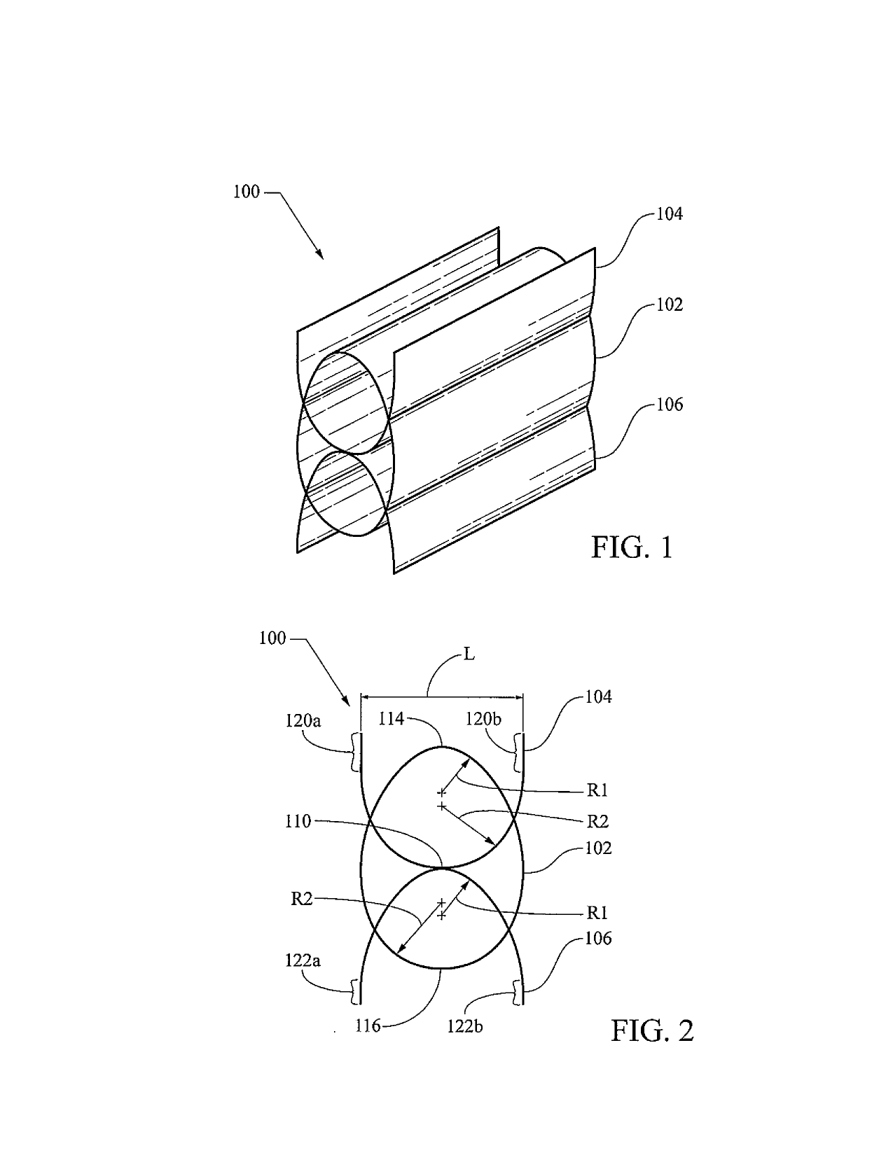

Referring to FIG. 1, an isometric view of an energy absorbing structure 100 of the present invention is shown. The structure 100 generally comprises an ovoid element 102, a first arch 104, and a second arch 106. Each of the arches 104 aid 106 generally includes a curved portion (i.e., apex) and two legs, and are generally inverted with respect to one another such that the legs of the arches are opposed. The arches 104 and 106 are generally nested into the ovoid 102 such that the structure 100 is an integrated unit (e.g., unitary device).

The elements 102, 104, and 106 are generally made (i.e., produced, manufactured, etc.) from the same material. Example materials that may be implemented in the manufacture of the structure 100 include aluminum, steel, titanium, composites, plastics, and the like. The device 100 may be made via casting, extrusion, pultrusion, joining of components, and the like as would be understood by one of ordinary skill in the art.

The elements of the structure 100 are illustrated as solid lines to emphasize that the structure 100 is generally a sacrificial device; that is, when implemented as shown on

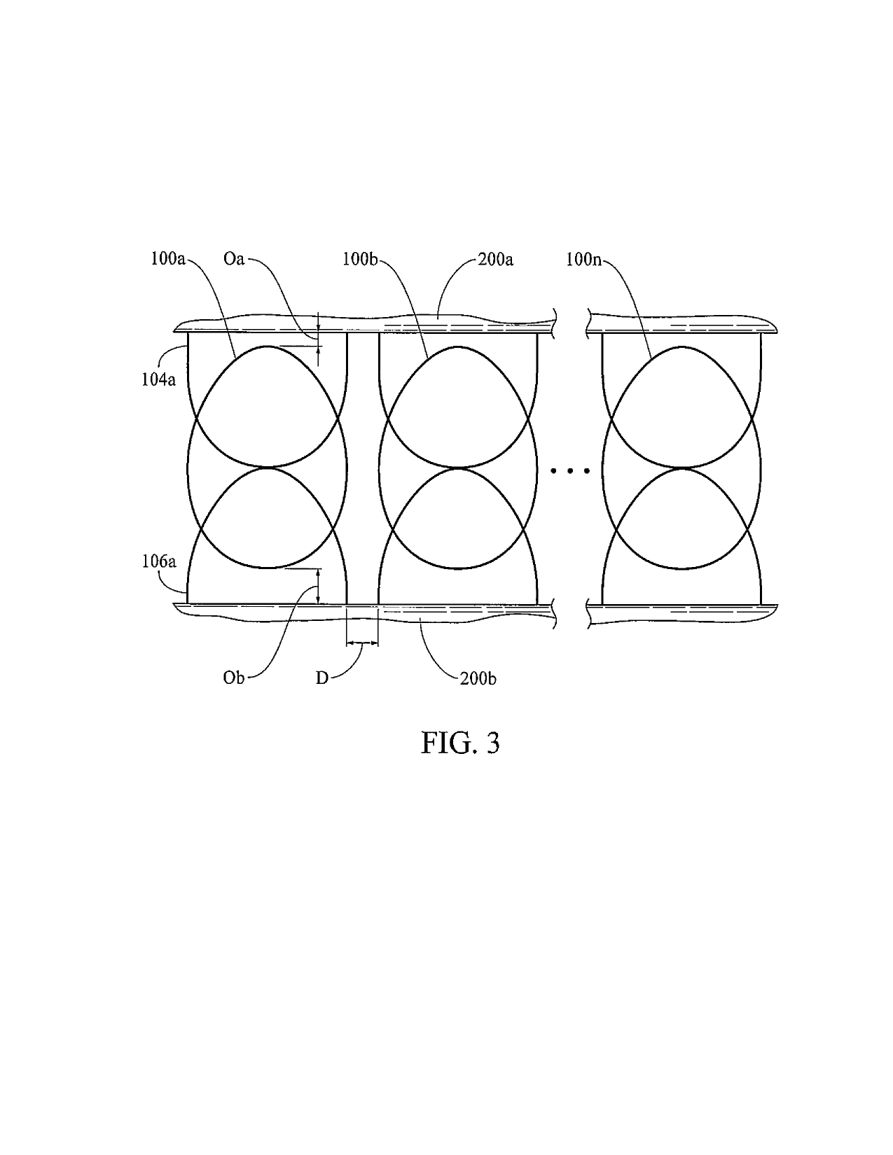

FIG. 3 and discussed in detail below, the device 100 is generally implemented as an apparatus that is configured to absorb energy via a crush response when a threat is encountered. An example of a similarly illustrated conventional protective device may be found, for example, in U.S. Pat. No. 7,597,040, issued Oct. 6, 2009 to Gabrys.

Referring to FIG. 2, an end view of the energy absorbing structure 100 is shown. The arches 104 and 106 are generally implemented as opposing “U” shapes having an intersection 110 of the apexes. The intersection 110 is generally located centrally within the oblong element 102. The elements 102, 104, and 106 are generally implemented having a lateral dimension (e.g., width), L, that is substantially equal for all three of the elements 102, 104, and 106.

The ellipsoidal element 102 may have a first end 114 with a first curvature having a first radius, R1; and an opposing, second end 116 with a second curvature having a second radius, R2. In one example embodiment, the radius R1 may be smaller than the radius R2. In another example embodiment (not shown), the radius R2 may be smaller than the radius R1. However, in other embodiments (not shown), the radii R1 and R2 may be substantially equal.

In one example embodiment (e.g., as illustrated on FIG. 2), the radius of the arch 104 may be implemented as substantially equal to the radius R2, and the radius of the arch 106 may be implemented as substantially equal to the radius R1. However, the radii of the arches 104 and 106 may be selected having any appropriate value to meet the design criteria of a particular application.

The U shaped elements 104 and 106 generally include legs as well as the curved sections. The first U shaped element 104 may comprise a first leg 120a and a second leg 120b. The second U shaped element 106 may comprise a first leg 122a and a second leg 122b. The arch legs may be straight in one example, and in an alternate example, one or more of the arch legs may be curved.

Referring to FIG. 3, an end view of an embodiment of an implementation of a plurality of the energy absorbing structure 100 is shown. A plurality of the structure 100 (e.g., devices 100a, 100b, 100n) are generally implemented as a system comprising the subassemblies 100 between a pair (i.e., first and second) of surfaces (e.g., walls, decks, bulkheads, and the like) 200 (e.g., first surface 200a and second surface 200b). Note, only sections (portions) of the surfaces 200a and 200b are illustrated. As noted above, the structure 100 is generally implemented as a sacrificial device; hence, the surfaces 200 may be implemented as physically more robust structures than the device 100.

The plurality of the devices 100 may be positioned near each other and separated by a gap (distance), D. In another example embodiment (not shown), the devices 100 may be substantially adjacent to successive devices 100. The ends 114 and 116 of the oblate element 102 are generally oriented towards the surfaces 200 (e.g., the first end 114 may be directed towards the surface 200a, and the second end may be directed towards the second surface 200b). The ends 114 and 116 of the oblate element 102 may be separated (offset) from the surfaces 200. For example, the ovoid 100a may be separated from the surface 200a by a distance Oa, and the ovoid 100a may be separated from the surface 200b by a distance Ob. The distances Oa and Ob may be implemented as substantially equal in one embodiment, and as unequal distances in another embodiment.

As illustrated on FIG. 3, the surfaces 200a and 200b may be substantially parallel; however, as understood by one of ordinary skill in the art, the surfaces 200a and 200b may be curved or otherwise formed to meet the design criteria of a particular application (e.g., vehicle door, fender, floor pan, roadside guard beam, etc.; not shown). The legs 120 and 122 of the arches 104 and 106, respectively, generally intersect and/or are fastened to the surfaces 200 (e.g., the legs 120 of the arch 104a may intersect the surface 200a, and the legs 122 of the arch 106a may intersect the surface 200b, and so forth).

At least one of the surfaces 200 is generally positioned between a body to be protected and an anticipated threat. When either or both of the surfaces 200 encounter the threat (typically a threat that is external to the combination of the devices 100 and the surfaces 200), one or more of the apparatuses 100 may collapse (e.g., the apparatus 100 is sacrificed) such that the energy that originates from the threat is absorbed.

As is apparent then from the above detailed description, the present invention may provide an improved system and an improved method for an energy absorbing structure 100.

Various alterations and modifications will become apparent to those skilled in the art without departing from the scope and spirit of this invention and it is understood this invention is limited only by the following claims.

What is claimed is:

1. An energy absorbing structure comprising:
an ovoid having a first end and a second end, wherein the first end and the second end are opposed;
a first arch; and
a second arch, wherein the arches are inverted with respect to one another such that first arch legs are opposed to second arch legs, and the arches are nested into the ovoid such that apexes of the arches intersect, and the first arch legs intersect a first surface and the second arch legs intersect a second surface, and the first end of the ovoid is directed towards the first surface and the second end of the ovoid is directed towards the second surface; and when a threat encounters either or both of the first and second surfaces, the structure collapses to absorb energy originated from the threat.

2. The structure of claim 1, wherein the first end of the ovoid is separated from the first surface by a first distance, and the second end of the ovoid is separated from the second surface by a second distance, and the first distance and the second distance are not equal.

3. The structure of claim 1, wherein the first end of the ovoid is separated from the first surface by a first distance, and the second end of the ovoid is separated from the second surface by a second distance, and the first distance and the second distance are substantially equal.

4. The structure of claim 1, wherein the first end has a first curvature having a first radius and the second end has a second curvature having a second radius, and the first radius and the second radius are not equal.

5. The structure of claim 1, wherein the first end has a first curvature having a first radius and the second end has a second curvature having a second radius, and the first radius and the second radius are substantially equal.

6. The structure of claim 1, wherein the structure is made from at least one of aluminum, steel, titanium, composites, and plastics.

7. An energy absorbing system comprising a plurality of subassemblies positioned between a first surface and a second surface, wherein each of the subassemblies comprises:
an ovoid having a first end and a second end, wherein the first end and the second end are opposed;
a first arch; and
a second arch, wherein the arches are inverted with respect to one another such that first arch legs are opposed to second arch legs, and the arches are nested into the ovoid such that apexes of the arches intersect, and the first arch legs intersect the first surface and the second arch legs intersect the second surface, and the first end of the ovoid is directed towards the first surface and the second end of the ovoid is directed towards the second surface; and when a threat encounters either or both of the first and second surfaces, at least one of the subassemblies collapses to absorb energy originated from the threat.

8. The system of claim 7, wherein the first end of the ovoid is separated from the first surface by a first distance, and the second end of the ovoid is separated the second surface by a second distance, and the first distance and the second distance are not equal.

9. The system of claim 7, wherein the first end of the ovoid is separated from the first surface by a first distance, and the second end of the ovoid is separated from the second surface by a second distance, and the first distance and the second distance are substantially equal.

10. The system of claim 7, wherein the first end has a first curvature having a first radius and the second end has a second curvature having a second radius, and the first radius and the second radius are not equal.

11. The system of claim 7, wherein the first end has a first curvature having a first radius and the second end has a second curvature having a second radius, and the first radius and the second radius are substantially equal.

12. The system of claim 7, wherein the subassemblies are made from at least one of aluminum, steel, titanium, composites, and plastics.

13. The system of claim 7, wherein the subassemblies are substantially adjacent.

14. A method for absorbing energy comprising:
positioning a plurality of subassemblies between a first surface and a second surface, wherein each of the subassemblies comprises:
an ovoid having a first end and a second end, wherein the first end and the second end are opposed;
a first arch; and
a second arch, wherein the arches are inverted with respect to one another such that first arch legs are opposed to second arch legs, and the arches are nested into the ovoid such that apexes of the arches intersect, and the first arch legs intersect the first surface and the second arch legs intersect the second surface, and the first end of the ovoid is directed towards the first surface and the second end of the ovoid is directed towards the second surface; and
positioning at least one of the surfaces between a body to be protected and an anticipated threat such that, when the threat encounters either or both of the first and second surfaces, at least one of the subassemblies collapses to absorb energy originated from the threat.

15. The method of claim 14, wherein the first end of the ovoid is separated from the first surface by a first distance, and the second end of the ovoid is separated from the second surface by a second distance, and the first distance and the second distance are not equal.

16. The method of claim 14, wherein the first end of the ovoid is separated from the first surface by a first distance, and the second end of the ovoid is separated from the second surface by a second distance, and the first distance and the second distance are substantially equal.

17. The method of claim 14, wherein the first end has a first curvature having a first radius and the second end has a second curvature having a second radius, and the first radius and the second radius are not equal.

18. The method of claim 14, wherein the first end has a first curvature having a first radius and the second end has a second curvature having a second radius, and the first radius and the second radius are substantially equal.

19. The method of claim 14, wherein the subassemblies are made from at least one of aluminum, steel, titanium, composites, and plastics.

20. The method of claim 14, wherein the subassemblies are substantially adjacent.
